(19) United States
(12) Patent Application Publication
(10) Pub. No.: US 2013/0189400 A1
(43) Pub. Date: Jul. 25, 2013

(54) SINGLE SERVE BEVERAGE DISPENSING SYSTEM INCLUDING AN IONIZER

(71) Applicant: Providence Enterprise, LLC, Newport Beach, CA (US)

(72) Inventors: Christopher C. Pribus, Laguna Beach, CA (US); John J. Fong, Irvine, CA (US); Brett D. Freeman, Aliso Viejo, CA (US)

(73) Assignee: PROVIDENCE ENTERPRISE, LLC, Newport Beach, CA (US)

(21) Appl. No.: 13/791,109

(22) Filed: Mar. 8, 2013

Related U.S. Application Data
(63) Continuation-in-part of application No. 13/442,742, filed on Apr. 9, 2012.
Application No. 13/442,742 is a continuation-in-part of application No. 13/442,738, filed on Apr. 9, 2012.
(60) Provisional application No. 61/537,218, filed on Sep. 21, 2011.
(60) Provisional application No. 61/538,328, filed on Sep. 23, 2011.

(51) Int. Cl. A47J 31/40; B65D 85/804

(52) U.S. Cl. CPC A47J 31/407; B65D 85/8043
USPC 426/115; 426/431; 99/295

(57) ABSTRACT

A single serve beverage dispensing device having a water reservoir from which water is drawn and ionized to produce alkaline water, which is returned to the water reservoir, and acidic water, which is routed to a waste water reservoir. The dispensing device includes a capsule holder for holding a beverage capsule including a powdered beverage media. The device includes a dispensing arm which punctures through the beverage capsule to and delivers the alkaline water into the capsule to mix with the beverage media. The beverage flows upward to exit the beverage capsule, and is then dispensed into a beverage receptacle.

### CROSS-REFERENCE TO RELATED APPLICATIONS

The present non-provisional patent application is a continuation-in-part of prior U.S. application Ser. No. 13/442,742, filed Apr. 9, 2012 entitled “Single Serve Beverage Dispensing System Including an Ionizer, which claims priority to U.S. Provisional Patent Application Ser. No. 61/537,218 filed on Sep. 21, 2011 entitled “Single Serve Functional Beverage Machine” and U.S. Provisional Patent Application Ser. No. 61/538,328 filed on Sep. 23, 2011 entitled “Single Serve Functional Beverage Machine,” the contents of both applications being incorporated herein by reference. The present non-provisional patent application is also continuation-in-part of U.S. application Ser. No. 13/442,738 filed Apr. 9, 2012 entitled “SINGLE SERVE BEVERAGE CAPSULE INCLUDING A MIXING CHAMBER WITH BEVERAGE MEDIA,” the contents of which are incorporated herein by reference.

### STATEMENT RE: FEDERALLY SPONSORED RESEARCH/DEVELOPMENT

Not Applicable

### BACKGROUND

1. Technical Field

The present disclosure generally relates to beverage dispensing devices, and more particularly, to a single serve beverage dispensing system including an ionizer.

2. Related Art

A water ionizer separates water into alkaline and acid fractions using a process known as electrolysis. It does this by exploiting the electric charge of the calcium and magnesium ions present in nearly all sources of tap drinking water. Alkaline is defined as having a pH value greater than 7.0. The pH value is a measure of the acidity or alkalinity of a solution. The pH scale runs from 0 to 14, with 7.0 considered neutral. pH values below 7.0 are considered acidic, and pH values above 7.0 are considered alkaline. Alkaline water may be utilized to improve the hydration of a person's body. In this regard, approximately 70% of a person's body is made up of water, and water is the medium through which cellular functions occur. Alkaline water is characterized as having reduced surface tension and reduced number of molecules in comparison to “ordinary” or tap water. As such, alkaline water may be used as an aid in transportation and absorption of vitamins, minerals, and other essential nutrients to various organs more rapidly than in compassion to ordinary water. Likewise, alkaline water is believed to detoxification of the body's cells as well.

There are a variety of consumer water ionizers available in the marketplace that are intended for home use. These devices are typically counter-mounted or under-counter mounted arrangements. A tap water line may be attached to the device or the device may have a water reservoir which the user periodically fills. In any event these devices are configured to allow alkaline water to be readily available “on tap.”

Bottled alkaline water is also available in the marketplace. However, these bottle beverages may not be as beneficial depending upon the product shelf life in comparison to ready-made alkaline water. Further, bottled beverages produce packaging waste.

In addition, there are a number of single-shot or single serve hot beverage dispensers available for home use. These dispensers utilize a single serve capsule that typically includes a filter and beverage medium, such as ground coffee or tea leaves. The dispenser injects a single serve amount of hot water into and through the single shot capsule. A hot water nozzle is pieced through a top of the capsule and an outlet nozzle is pierced through the bottom of the capsule. Hot water is injected from the hot water nozzle. The resulting liquid beverage is then dispensed through the outlet nozzle into a user's cup. In this regard, the hot water is used to extract elements of the beverage medium to form the resulting liquid beverage with a remainder of the beverage medium (e.g., coffee grinds or tea leaves) remaining in the used capsule for disposal.

So-called functional beverages are beverage products that are non-alcoholic, ready to drink and include in their formulation non-traditional ingredients. This may include herbs, vitamins, minerals, amino acids or additional raw fruit or vegetable ingredients, so as to provide specific health benefits that go beyond general nutrition. Sports and performance drinks, energy drinks, ready to drink (RTD) teas, enhanced fruit drinks, soy beverages and alkaline water, among others, are some of the product marketed as functional beverages. Functional beverages are widely available in premixed bottles and cans. However, such bottle/can product packaging is considered wasteful or waste producing and therefore undesirable from this perspective alone. Moreover, the inherent nature of bringing functional beverages to market in bottles and cans is relatively expensive. Functional beverages are also available in beverage power form in packet packaging that required manual mixture with water. Insufficient manual mixture may result in undissolved portions of the beverage power being present at the bottom of a beverage cup.

It is contemplated that the above described prior art beverages and beverage dispensing systems are limited in terms of variety of beverage selection, cost and packaging constraints and means of dispensing. Accordingly, there is a need in the art for an improved beverage dispensing system.

### BRIEF SUMMARY

According to an aspect of the invention, there is provided a single serve beverage dispensing device configured for use with a single serve beverage capsule, wherein the capsule includes a capsule body and a capsule covering coupled to the capsule body to define an internal chamber for storing a beverage media. The single serve beverage dispensing device includes a housing having a primary reservoir cavity, a waste reservoir cavity, and a capsule holder configured to be selectively engageable with the beverage capsule. A dispensing arm is coupled to the housing and is transitional relative to the housing between open and closed positions. The dispensing arm moves toward the capsule holder as the dispensing arm transitions from the open position to the closed position. The dispensing arm includes a dispensing head having a central inlet opening and a plurality of outlet openings disposed about the inlet opening. A plurality of outlet spears are coupled to the dispensing head and are positioned adjacent respective ones of the plurality of outlet openings. The plurality of outlet spears are configured to puncture the capsule covering when the beverage capsule is engaged with the capsule holder and the dispensing arm is moved to the closed position. The dispensing device includes a primary water reservoir body defining a primary water reservoir and configured to be removably insertable within the primary reservoir cavity, and a waste water reservoir body defining a waste water reservoir and configured to be removably insertable within the waste reservoir cavity. An ionizer is in fluid communication with the primary water reservoir, and the waste water reservoir. The ionizer is configured to produce alkaline water and acidic water from water in the primary water reservoir. A pump is in fluid communication with the primary water reservoir, the ionizer, the waste water reservoir and the inlet opening. The pump is configured to complete an ionizing cycle wherein water from the primary water reservoir is pumped through the ionizer, wherein the alkaline water is pumped to the primary water reservoir and the acidic water is pumped to the waste water reservoir. The pump is further configured to complete a beverage mixing cycle, wherein alkaline water from the primary water reservoir is pumped through the inlet opening to mix with beverage media in the beverage capsule and exits the beverage capsule through the plurality of outlet openings.

The dispensing device may include a three-way valve in fluid communication with the primary water reservoir, the ionizer and the inlet opening. The three-way valve may include a primary reservoir inlet, an ionizing outlet, and a mixing outlet, wherein during the ionizing cycle, the three-way valve may be configured to effectuate fluid communication between the primary water reservoir and the ionizer by opening the primary reservoir inlet and the ionizing outlet and closing the mixing outlet, and during the beverage mixing cycle, the three-way valve may be configured to effectuate fluid communication between the primary water reservoir and the inlet opening by opening the primary reservoir inlet and the mixing outlet and closing the ionizing outlet.

The plurality of outlet openings may be disposed about the inlet opening in a radial pattern.

The dispensing head may be disposed above the capsule holder when the dispensing arm is in the closed position such that the water flows against the force of gravity to traverse a horizontal plane when the water exits the beverage capsule through the plurality of outlet openings.

The dispensing arm may further include an inlet spear disposed adjacent the inlet opening.

The capsule holder may include a capsule holding aperture formed within the housing, and a removable capsule holding body insertable within the aperture and engageable with the beverage capsule. The capsule holding body may include a dispensing opening in communication with the plurality of outlet openings when the capsule holding body is inserted within the capsule holding aperture and the dispensing arm is in the closed position. The plurality of outlet openings may be fluidly coupled to the dispensing opening via an outlet passageway formed within the dispensing arm, wherein the outlet passageway is substantially perpendicular to the dispensing opening when the dispensing arm is in the closed position.

The dispensing arm may include an arm base, wherein the dispensing head may be detachably engageable with the arm base.

According to another aspect of the present invention, there is provided a method of producing a single-serve beverage. The method includes providing a single serve beverage dispenser including a primary water reservoir, a waste water reservoir, and an ionizer in fluid communication with the primary water reservoir and the waste water reservoir. The primary water reservoir is filled with water, and the water from the primary water reservoir is pumped through the ionizer to produce alkaline water and acidic water. The alkaline water is routed to the primary water reservoir and the acidic water is routed to the waste reservoir. The alkaline water in the primary water reservoir is used to make a single serve beverage by mixing the alkaline water with beverage media in a single serve beverage capsule.

The presently contemplated embodiments will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a perspective view of a single serve beverage dispenser according to an aspect of the invention;

FIG. 2 is a perspective view of the beverage dispenser with a primary water reservoir body and a waste water reservoir body removed from a dispenser housing;

FIG. 3 is a partial upper perspective view of the beverage dispenser including a dispensing arm in an open position and a capsule holder removed from the dispenser housing, and a beverage capsule removed from the capsule holder;

FIG. 4 is a lower perspective view of a dispensing dispensing head and an dispensing head insert engaged with the dispensing head;

FIG. 5 is an upper perspective view of the dispensing dispensing head;

FIG. 6 is an exploded lower perspective view of the dispensing dispensing head and the dispensing head insert;

FIG. 7 is a symbolic diagram of a fluid system associated with the single serve beverage dispenser;

FIG. 8 is a symbolic diagram of an electrical system associated with the single serve beverage dispenser;

FIG. 9 is a partial side sectional view of the dispensing arm in the open position and the capsule holder, the capsule holder removed from the dispenser housing, and the beverage capsule removed from the capsule holder;

FIG. 10 is a partial side sectional view of the dispensing arm transitioning from the open position toward a closed position, and the capsule holder engaged with the dispenser housing and the beverage capsule inserted within the capsule holder;

FIG. 11 is a partial side sectional view of the dispensing arm in the closed position;

FIG. 12 is a partial side sectional view depicting fluid flow through a dispensing inlet, mixing in the beverage capsule, through outlet apertures and through a dispensing opening; and

FIG. 13 is a side view of the beverage dispenser including a partial sectional view of a portion of the dispenser that engages with a single serve beverage capsule.

Common reference numerals are used throughout the drawings and the detailed description to indicate the same elements.

### DETAILED DESCRIPTION

The detailed description set forth below in connection with the appended drawings is intended as a description of the presently preferred embodiments of the invention, and is not intended to represent the only form in which the present devices may be developed or utilized. It is to be understood, however, that the same or equivalent functions may be accomplished by different embodiments that are also intended to be encompassed within the spirit and scope of the invention. It is further understood that the use of relational terms such as first, second, and the like are used solely to distinguish one from another entity without necessarily requiring or implying any actual such relationship or order between such entities.

Referring now to the drawings, wherein the showings are for purposes of illustrating a preferred embodiment of the present invention, and are not for purposes of limiting the same, there is depicted a single serve beverage dispensing device 10 configured to ionize conventional tap water to increase the pH level of the water and to mix the ionized water with beverage media in a single serve beverage capsule to create a single serve beverage.

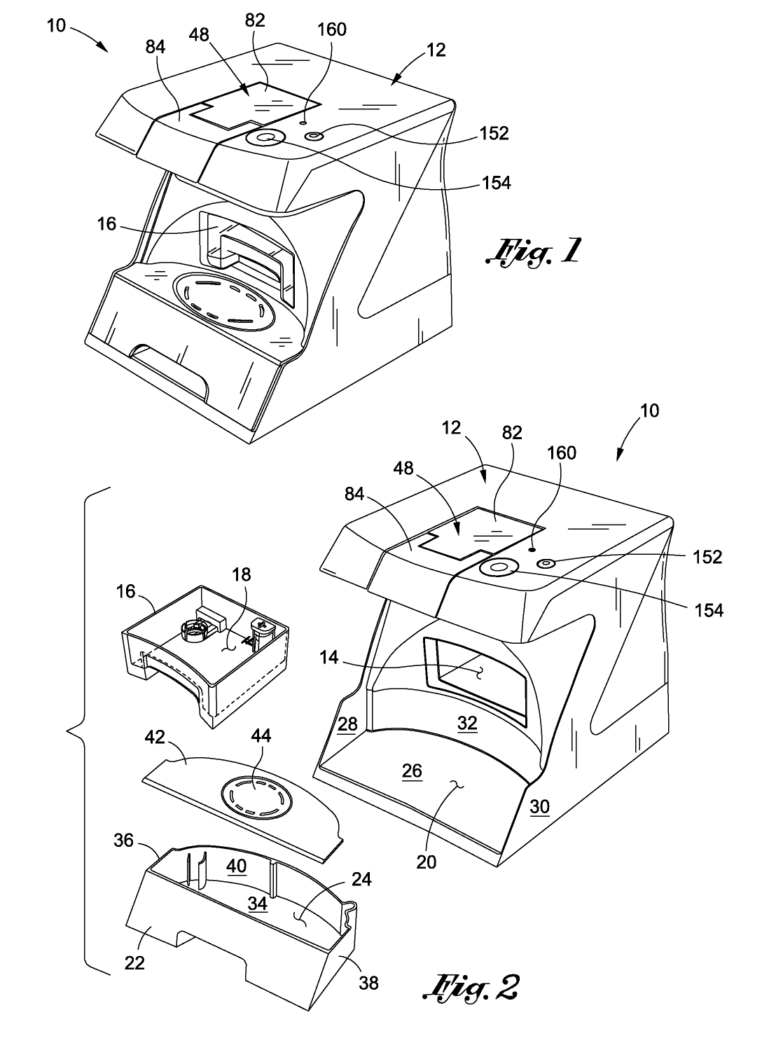

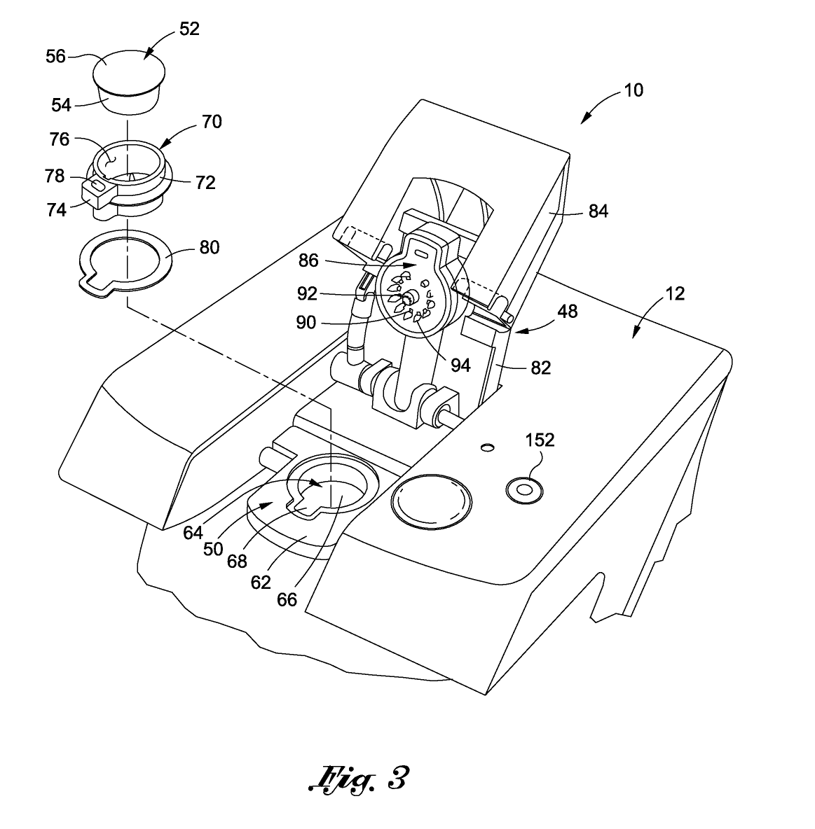

FIGS. 1 and 2 depict an embodiment of the beverage dispensing device 10 which includes a housing 12 having a primary reservoir cavity 14 which is sized and configured to receive a primary reservoir body 16 defining a primary reservoir 18. The primary reservoir cavity 14 is configured to slideably receive the primary reservoir body 16 therein. The primary reservoir cavity 14 and the primary reservoir body 16 are preferably configured such that when the primary reservoir body 16 is received within the primary reservoir cavity 14, the primary reservoir body 16 does not protrude therefrom, and is contained within the primary reservoir cavity 14. In the exemplary embodiment the primary reservoir cavity 14 and the primary reservoir body 16 define a quadrangular shape in at least one cross sectional plane, although other shapes and configures may be defined by other embodiments of the primary reservoir cavity 14 and primary reservoir body 16.

The housing 12 additionally includes a waste reservoir cavity 20 sized and configured to receive a waste reservoir body 22 defining a waste reservoir 24. In the exemplary embodiment the waste reservoir cavity 20 is defined by a bottom wall 26, a pair of side walls 28, 30, and a back wall 32. The waste reservoir body 22 is complimentary in shape to the waste reservoir cavity 20 and includes a bottom wall 34, pair of side walls 36, 38, and a back wall 40 that correspond to the bottom wall 26, side walls 28, 30 and back wall 32 of the housing 12, such that the waste reservoir body 22 assumes a nested position relative to the housing 12 when it is received within the waste reservoir cavity 20.

A waste reservoir lid 42 may be placed on the waste reservoir body 22 to cover the waste reservoir 24. The waste reservoir lid 42 may additionally serve as a support surface upon which a cup or other beverage receptacle may be placed to receive the beverage during dispensing. Along these lines, the waste reservoir lid 42 may include markings, delineations, indicia or the like defining a prescribed area on the lid 42 upon which the beverage receptacle should be placed to capture the dispensed beverage as it is dispensed from the device 10.

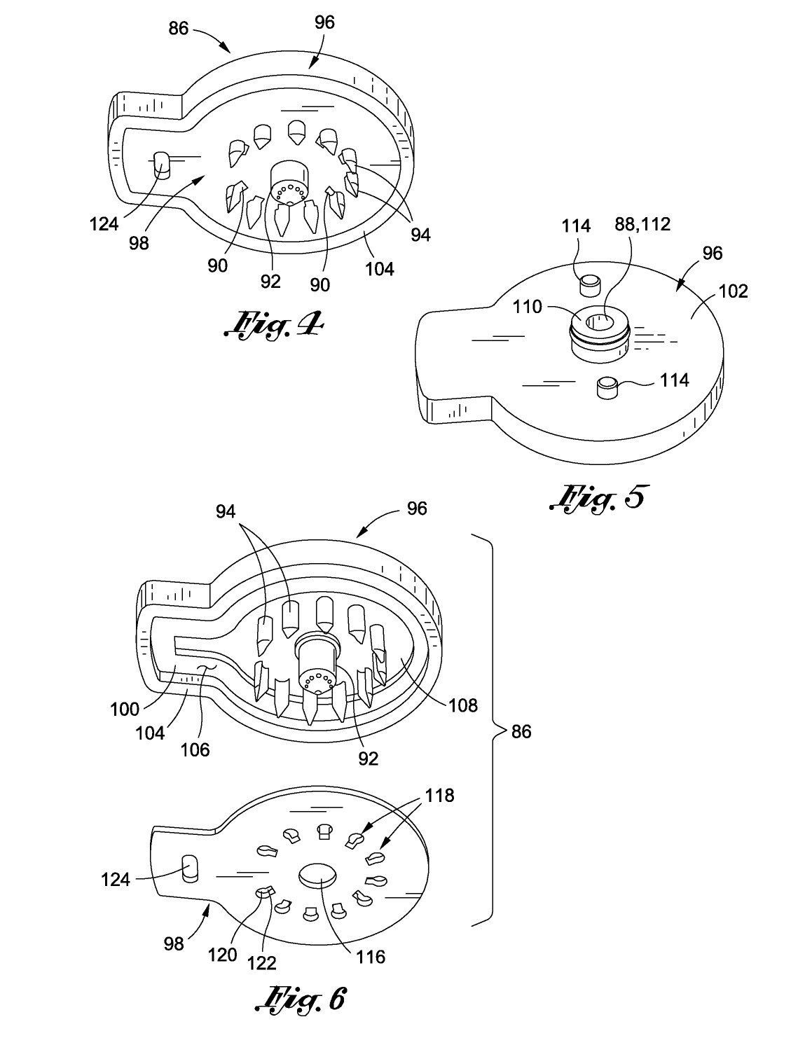

FIG. 3 is a partial upper perspective view of the device 10 which depicts a dispensing arm 48 in a raised, open position relative to the housing 12 to expose a capsule holder 50 configured to engage with a beverage capsule 52. The beverage capsule 52 generally includes a capsule body 54 and a capsule covering 56 coupled to the capsule body 54, wherein the capsule body 54 and capsule covering 56 collectively define an internal chamber 58 (see FIG. 7) for storing a beverage media 60 (see FIG. 7). The capsule covering 56 is preferably secured to the capsule body 54 via heat sealing or via an adhesive. The capsule body 54 and capsule covering 56 are preferably formed from a food grade plastic or foil. The beverage media 60 may be a flavored, powdered substance that, when mixed with water, creates a flavored beverage.

According to one embodiment, the capsule holder 50 includes a capsule holding plate 62 coupled to the housing 12 and defining a holding aperture 64. The exemplary holding aperture 64 includes a circular portion 66 and a rectangular portion 68 in communication with the circular portion 66. A removable capsule holding body 70 is insertable within the holding aperture 64 and is engageable with the beverage capsule 52 to hold and secure the beverage capsule 52 during mixing and dispensing. The exemplary capsule holding body 70 includes a circular portion 72 and a rectangular portion 74 that corresponds to the circular and rectangular portions 66, 68 of the exemplary holding aperture 64. The configuration of the holding aperture 64 and the capsule holding body 70 ensure that the capsule holding body 70 is properly aligned with respect to the holding aperture 64 when the holding body 70 is received in the aperture 64.

The circular portion 72 of the holding body 70 defines a cavity 76 sized and configured to receive the capsule body 54. As will be explained in more detail below, the capsule body 54 preferably defines a toroidal shape, and thus, the holding body 70 preferably defines a complimentary toroidal shape (see FIG. 10). The rectangular portion preferably includes a dispensing opening 78 through which the beverage may be dispensed, as will be discussed in more detail below. An optional spacer or shim element 80 may be placed between the capsule holding body 70 and the capsule holding plate 62 if desired.

The dispensing arm 48 includes a first pivot portion 82 pivotally coupled to the housing 12, and a second pivot portion 84 pivotally coupled to the first pivot portion 82. A dispensing head 86 is coupled to the first pivot portion 82 and is configured to deliver water into the beverage capsule 52. Furthermore, the unique configuration of the dispensing head 86 and beverage capsule 52 allows the mixed beverage (e.g., the water mixed with the beverage media 60) to exit the beverage capsule 52 through the dispensing head 86 for dispensing into a beverage receptacle.

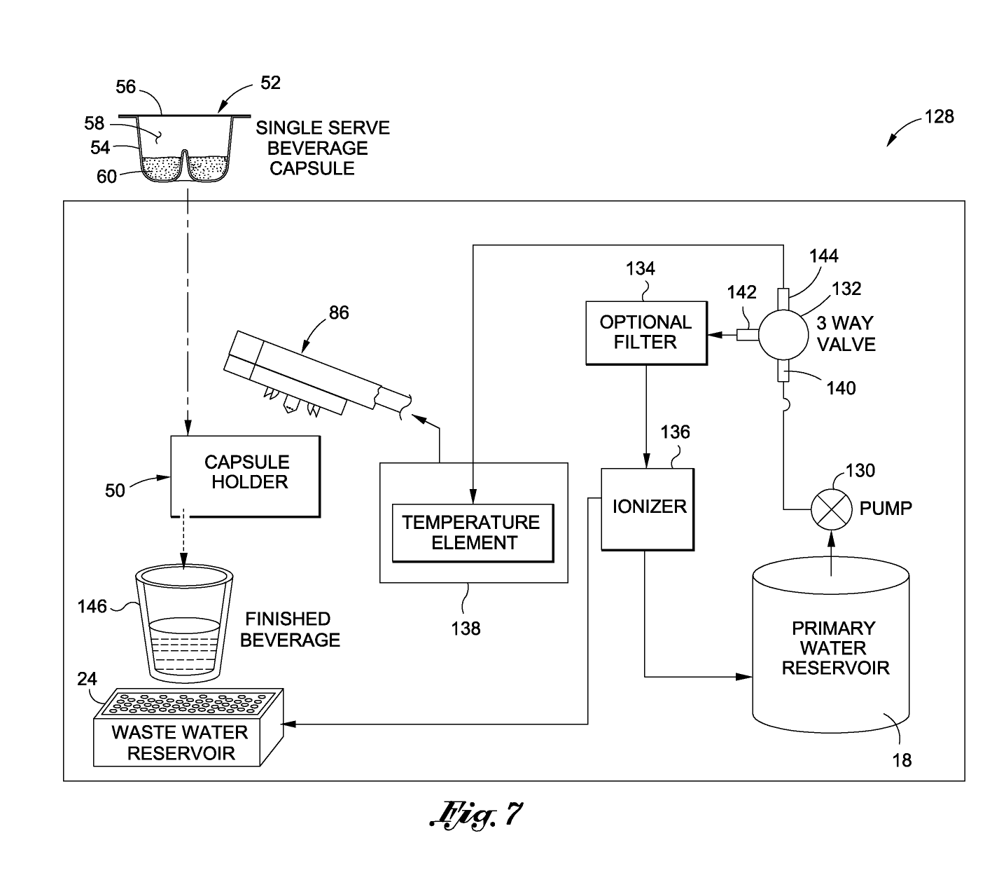

FIGS. 4 and 5 are respective upper and lower perspective view of the dispensing head 86, which includes a central inlet opening 88 and a plurality of outlet openings 90 disposed about the inlet opening 88. The outlet openings 90 are preferably disposed about the inlet opening 88 in a radial pattern. An inlet spear 92 is coupled to the dispensing head 86 and is coaxially aligned with the inlet opening 88. The inlet spear 92 includes an inner spear opening that is in communication with the inlet opening 88. According to various aspects of the present invention, the inlet spear 92 is a cannula-like structure configured to pierce the capsule covering 56 of the beverage capsule 52 for delivering fluid into the beverage capsule 52 via the inner opening of the inlet spear 92 for mixing with the beverage media 60. A plurality of outlet spears 94 are coupled to the dispensing head 86 and are positioned adjacent respective ones of the plurality of outlet openings 90. The inlet spear 92 and outlet spears 94 may be formed of copper, plastic, rubber or other materials known in the art capable of enduring repeated exposure to liquids.

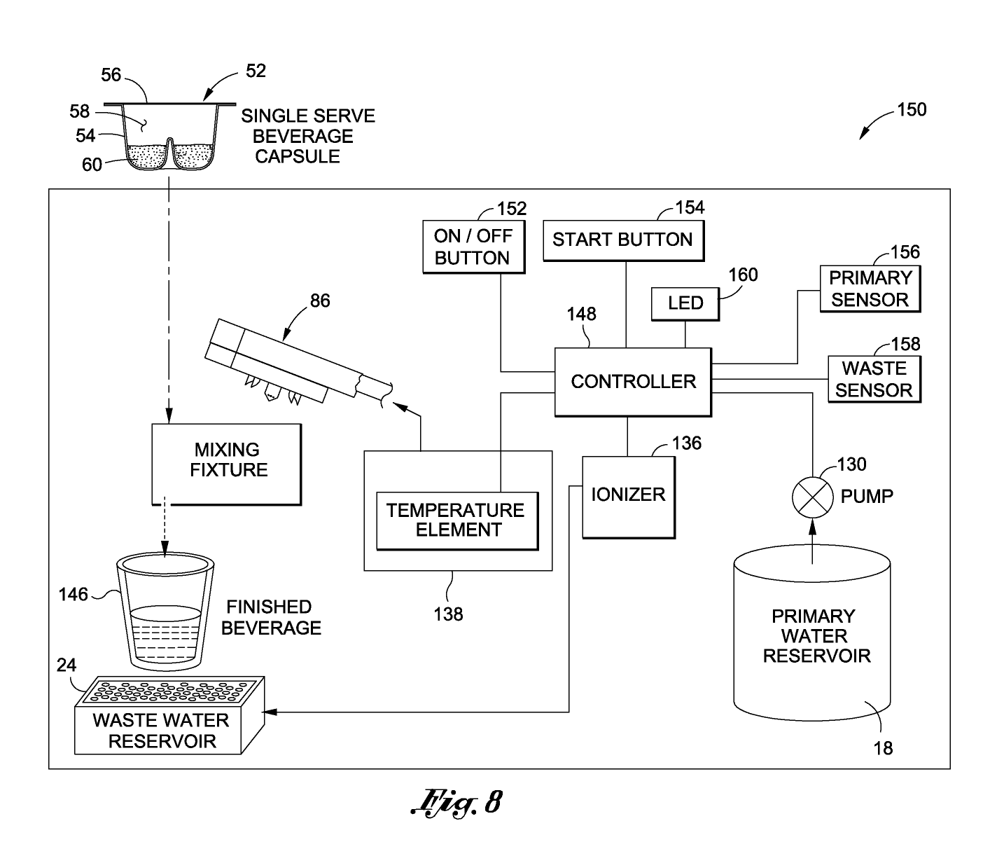

In one implementation of the invention, the dispensing head 86 includes a dispensing head body 96 and a dispensing head insert 98 engageable with the dispensing head body 96. FIG. 4 shows the dispensing head insert 98 nested within a cavity formed in the dispensing head body 96, while FIG. 6 is an exploded view showing the dispensing head insert 98 disengaged from the dispensing head body 96.

The dispensing head body 96 includes a first surface 100 an opposing second surface 102, and a peripheral wall 104 that extends about the outer periphery of the dispensing head body 96. The peripheral wall 104 and the first surface 100 collectively define the cavity 106 within which the dispensing head insert 98 is received. The dispensing head body 96 additionally includes a third surface 108 which is recessed into the dispensing head body 96 relative to the first surface 100 and faces the same direction as the first surface 100. The inlet spear 92 and the plurality of outlet spears 94 extend from the third surface 108. The dispensing head body 96 additionally includes an inlet element 110 extending from the second surface 102 and having an opening 112 in fluid communication with the central inlet opening 88.

The dispensing head body 96 is detachably connectable to an arm base (e.g., the first and second pivot portions 82, 84 of the dispensing arm 48). When the dispensing head body 96 is connected to the first pivot portion 82, the second surface 102 faces the first pivot portion 82 and the first surface 100 faces away from the first pivot portion 82. Preferably, the inlet element 110 is received within an opening formed within the first pivot portion 82 and engages with the first pivot portion 82. The dispensing head body 96 includes one or more guide posts 114 extending from the second surface 102 to ensure proper alignment of the dispensing head body 96 with the first pivot portion 82 of the dispensing arm 48. The guide posts 114 are received within corresponding guide cavities formed within the first pivot portion 82 of the dispensing arm 48.

The dispensing head insert 98 is separate from the dispensing head body 96 and includes a central opening 116 and a plurality of outward openings 118 disposed about the central opening 116 and arranged in a radial pattern. The arrangement of the outward openings 118 corresponds to the arrangement of the outlet spears 94. Each outward opening 118 includes a spear portion 120 sized and configured to allow a respective outlet spear 94 to extend therethrough, and an extension portion 122 sized and configured to define the outlet openings 94 when the dispensing head insert 98 is engaged with dispensing head body 96. The dispensing head insert 96 additionally includes an exit opening 124 spaced from the outward openings 118 and the central opening 116.

When the dispensing head insert 98 is nested within the dispensing head body 96, the dispensing head insert 98 and the third surface 108 define a dispensing head fluid passageway 126 (see FIG. 13). The dispensing head fluid passageway 126 is in fluid communication with the exit opening 124, which in turn, is in fluid communication with the dispensing opening 78 formed within the capsule holding body 70 for dispensing the mixed beverage, as will be described in more detail below.

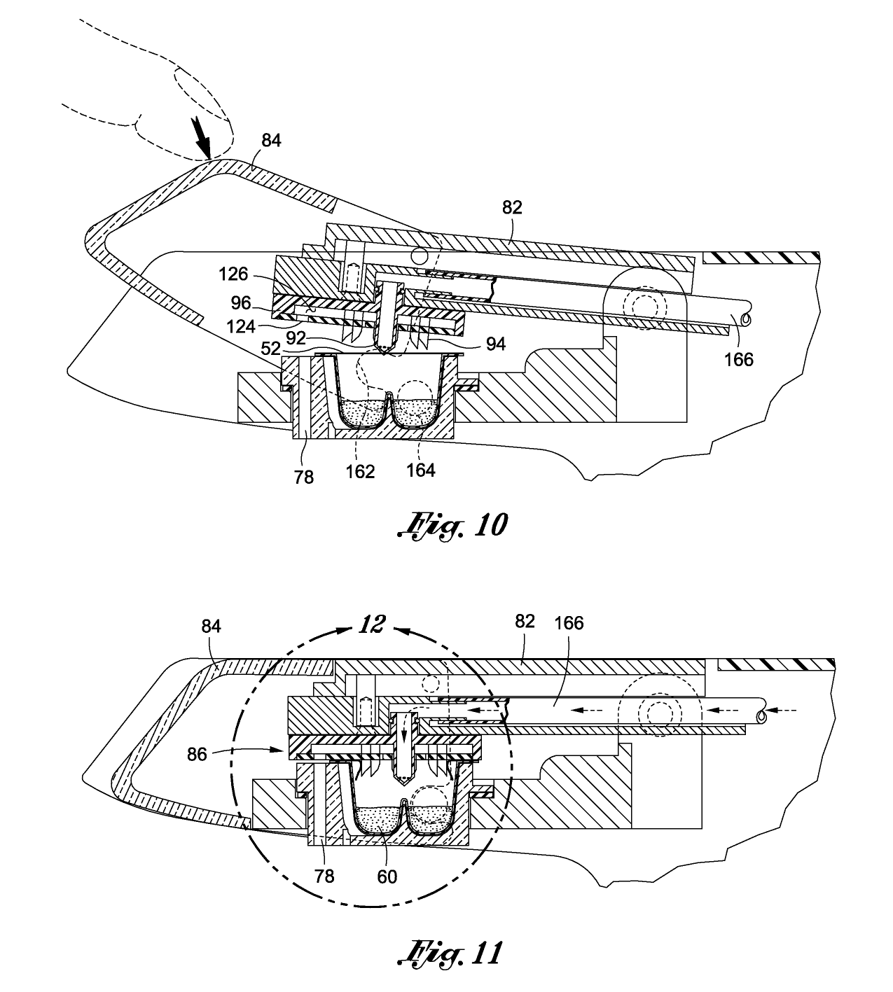

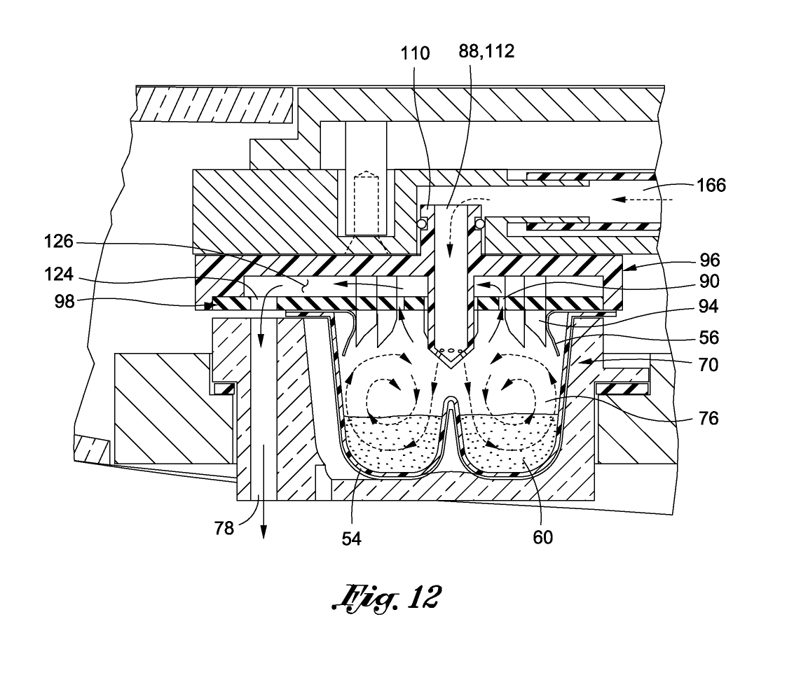

The dispensing arm 48 is transitional relative to the housing 12 between an open position, as is shown in FIGS. 3 and 9, and a closed position, as is shown in FIGS. 11, 12, and 13. The dispensing arm 48 moves toward the capsule holder 50 as the dispensing arm 48 transitions from the open position to the closed position. As the dispensing arm 48 moves from the open position toward the closed position, the inlet spear 92 and the plurality of outlet spears 94 are configured to puncture the capsule covering 56 to effectuate fluid communication between the dispensing head 86 and the beverage capsule 52 when the beverage capsule 52 is inserted in the capsule holder 50.

Referring now to FIG. 7, there is depicted a schematic diagram of one embodiment of a fluid system 128 associated with the dispensing device 10. The fluid system 128 includes the primary reservoir 18, a pump 130, three-way valve 132, filter 134, ionizer 136, temperature element 138, dispensing head 86, capsule holder 50, and waste water reservoir 24.

The pump 130 is in fluid communication with the primary water reservoir 18 and the three-way valve 132 and is configured to pump water from the primary water reservoir 18 through the remainder of the fluid system 128.

The three-way valve 132 is configured to receive water from the pump 130 direct water through the system according to an operational cycle. The three-way valve 132 includes one valve inlet 140 and a pair of valve outlets 142, 144. The valve inlet 140 is in fluid communication with the pump 130. A first valve outlet 142 (e.g., an ionizing outlet) is in fluid communication with the filter 134 and a second valve outlet 144 (e.g., a mixing outlet) is in fluid communication with the temperature element 138. The three-way valve 132 is configured to open and close the first and second valve outlets 142, 144 in accordance with the operational cycle, as will be described in more detail below.

The ionizer 136 is configured to produce alkaline water and acidic water from conventional tap water. The alkaline water is subsequently mixed with the beverage media 60 in the beverage capsule 52, while the acidic water is routed to the waste water reservoir 24. The ionizer 136 receives water via the first valve outlet 142 of the three-way valve 132. According to one embodiment, the water received by the ionizer 136 passes through the filter 134, although it is contemplated that other embodiments may not include the filter 134, in which case, the water may be received by the ionizer 136 directly from the three-way valve 132.

The temperature element 138 receives water from the three-way valve 132 and heats or cools the water before it passes through the dispensing head 86. It is contemplated that some implementations of the present invention may not include a temperature element 138, in which case, water may be received by the dispensing head 86 directly from the three-way valve 132.

The fluid system 128 is configured to complete an ionizing cycle and a beverage mixing cycle. In the ionizing cycle, water from the primary water reservoir 18 is pumped through the ionizer 136, and the alkaline water produced by the ionizer 136 is pumped to back to the primary water reservoir 18, while the acidic water produced by the ionizer 136 is pumped to the waste water reservoir 24. The beverage mixing cycle is performed subsequent to the ionizing cycle after the alkaline water is returned to the primary water reservoir 18. During the beverage mixing cycle, the alkaline water from the primary water reservoir 18 is pumped through the dispensing head 86 to mix with beverage media 60 in the beverage capsule 52 and is dispensed into a beverage receptacle 146.

During the ionizing cycle, the three-way valve 132 is configured to effectuate fluid communication between the primary water reservoir 18 and the ionizer 136 by opening the valve inlet 140 and the ionizing outlet 142 and closing the mixing outlet 144. During the beverage mixing cycle, the three-way valve 132 is configured to effectuate fluid communication between the primary water reservoir 18 and the dispensing head 86 by opening the valve inlet 140 and the mixing outlet 144 and closing the ionizing outlet 142.

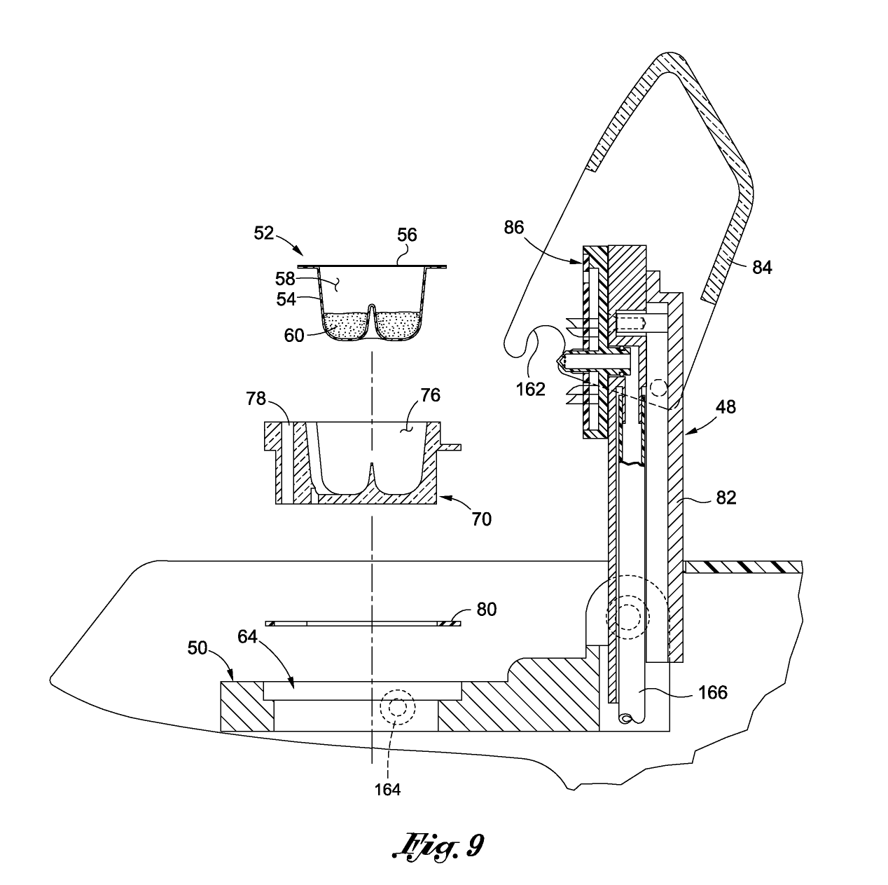

The operation of the device 10 is controlled by a controller 148, which is shown in FIG. 8 depicting a schematic diagram of the electrical system 150 associated with the device 10. The electrical system 150 includes the controller 148, the pump 130, the ionizer 136, the temperature element 138, as well as the ON/OFF button 152, the START button 154, the primary sensor 156, the waste sensor 158, and LED light 160.

The controller 148 may be programmed to operate the pump 130 for a preset period of time to complete the ionizing cycle. The preset period of time may be based on the primary water reservoir 18 being filled to a prescribed level. Furthermore, the controller 148 may be programmed to operate the pump 130 for a preset period of time to complete the mixing cycle. The preset period of time for the mixing cycle may be based on a prescribed level of alkaline water being present in the primary water reservoir 18 at the beginning of the mixing cycle.

The ON/OFF button 152 is operative to control the power supply to the device 10 to turn the device 10 on or off. In the exemplary embodiment, the ON/OFF button 152 is located on the top of the housing 12 and is easily accessible by the user. The power may be supplied via a power cord connectable to a conventional wall mounted power socket, or via an internal power supply, e.g., batteries.

The START button 154 is operative to initiate operation of the device 10. As will be described in more detail below, when the START button 154 is pressed, the pump 130 is actuated to initiate the ionizing cycle.

The primary sensor 156 is in operative communication with the primary water reservoir 18 to ensure there is a sufficient amount of water in the primary water reservoir 18 to make the beverage. If there is enough water detected by the primary sensor 156, the primary sensor 156 may communicate a GO signal to the controller 148 to proceed with the beverage dispensing operation. Conversely, if the water levels in the primary water reservoir 18 are insufficient, the primary sensor 156 will communicate a STOP signal to the controller 148 to prevent further operation, which could cause harm to the pump 130 if the pump 130 runs without water.

The waste sensor 158 is in operative communication with the waste water reservoir 24 to ensure there is enough free space within the waste water reservoir 24 to accommodate the acidic water generated during the ionizing cycle. If there is enough free space, the waste sensor 158 may communicate a GO signal to the controller 148 to proceed with the beverage dispensing operation. However, if there is insufficient free space, the waste sensor 158 may communicate a STOP signal to the controller 148 to prevent further operation, which would otherwise cause overflow of the waste water reservoir 24.

According to one embodiment, the primary sensor 156 and the waste sensor 158 are conventional float sensors.

The LED light 160 is operative to illuminate in accordance with various operational conditions. For instance, the LED 160 may illuminate at a first color or frequency when the device 10 is turned ON. The LED 160 may illuminate at a second color or frequency after the START button 154 is pressed and the device 10 proceeds through the beverage dispensing operation. The LED 160 may illuminate at a third color if the primary sensor 156 detects that the water level in the primary water reservoir 18 is insufficient. The LED 160 may illuminate at a fourth color or frequency if the waste sensor 158 detects that the water level in the waste water reservoir 24 is too high.

Reference is now made to FIG. 9-13, which relate to operation of one embodiment of the device 10. Operation of the device 10 requires the user to place a beverage capsule 52 within the capsule holder 50 and to fill the primary water reservoir 18 with water. There is not requirement that one of these tasks be completed before the other. The following description describes insertion of the beverage capsule 52, followed by filling of the primary water reservoir 18. However, those skilled in the art will readily appreciate that the primary water reservoir 18 may be filled before the capsule 52 is inserted.

Referring now to FIG. 9, the dispensing arm 48 is lifted to the open position and a beverage capsule 52 is placed within a capsule holding body 70, which is positioned within the holding aperture 64 of the capsule holder 50.

Referring now to FIG. 10, the dispensing arm 48 is transitioned from the open position toward the closed position. A user may lower the dispensing arm 48 from the open position toward the closed position until the dispensing arm 48 is in the position shown in FIG. 10. At the position shown in FIG. 10, the inlet spear 92 is resting on top of the capsule covering 52 and the outlet spears 94 may be positioned above the capsule covering 52.

The user presses down on the second pivot portion 84 to continue toward the closed position. The movement of the dispensing arm 48 toward the closed position causes the inlet spear 92 and outlet spears 94 to puncture the capsule covering 52 and advance through the capsule covering 52, as shown in FIG. 11. Furthermore, when the dispensing arm 48 is in the closed position, the cutout 162 is engaged with the rod 164, and the exit opening 124 on the dispensing arm 48 is aligned with, and in fluid communication with, the dispensing opening 78 formed in the capsule holding body 70.

As noted above, operation of the device requires that the primary water reservoir 18 is filled with water. The reservoir 18 is filled by removing the primary reservoir body 16 from the primary reservoir cavity 14 and filling the reservoir 18 with water. The primary water reservoir 18 may include markings, e.g., a line, to provide the user with a reference point when filing the primary water reservoir 18.

The user should additionally check to see if the waste water reservoir 24 is full. If so, the waste water reservoir 25 should be emptied to create space for the acidic water produced during the ionizing cycle.

When the primary water reservoir 18 is filled, the waste water reservoir 25 is empty, and the dispensing arm 48 is in the closed position, the fluid cycle can be initiated by pressing the START button 154. The pump 130 draws the tap water out of the primary water reservoir 18 and directs the water to the three-way valve 132, which is in the ionizing configuration with the inlet 140 open, the ionizing outlet 142 open, and the mixing outlet 144 closed. The water leaves the three-way valve 132, and passes through the filter 134 and enters the ionizer 136, where the water is separated into an alkaline portion and an acidic portion. The ionizer outputs the alkaline portion back to the primary water reservoir 18, while the acidic portion is directed to the waste water reservoir 24. According to one implementation, approximately two-thirds of the tap water originally drawn from the primary water reservoir 18 returns to the primary water reservoir 18 as the alkaline portion, while the remaining one-third of the tap water is directed to the waste water reservoir 24 as the acidic portion.

After all of the alkaline water returns to the primary water reservoir 18, the three-way valve 132 transitions from the ionizing configuration to the mixing configuration, with the inlet 140 open, the ionizing output 142 closed and the mixing outlet 144 open. The pump 130 draws the ionized water from the primary water reservoir 18 and pumps the water through the three-way valve 132 and to the temperature element 138 which adjusts the temperature of the ionized water to the preferred temperature. Those skilled in the art will recognize that the temperature element 138 is optional in embodiments of the invention without temperature control. The ionized water then flows to the dispensing head 86 via delivery tube 16, as shown by arrows in FIG. 11.

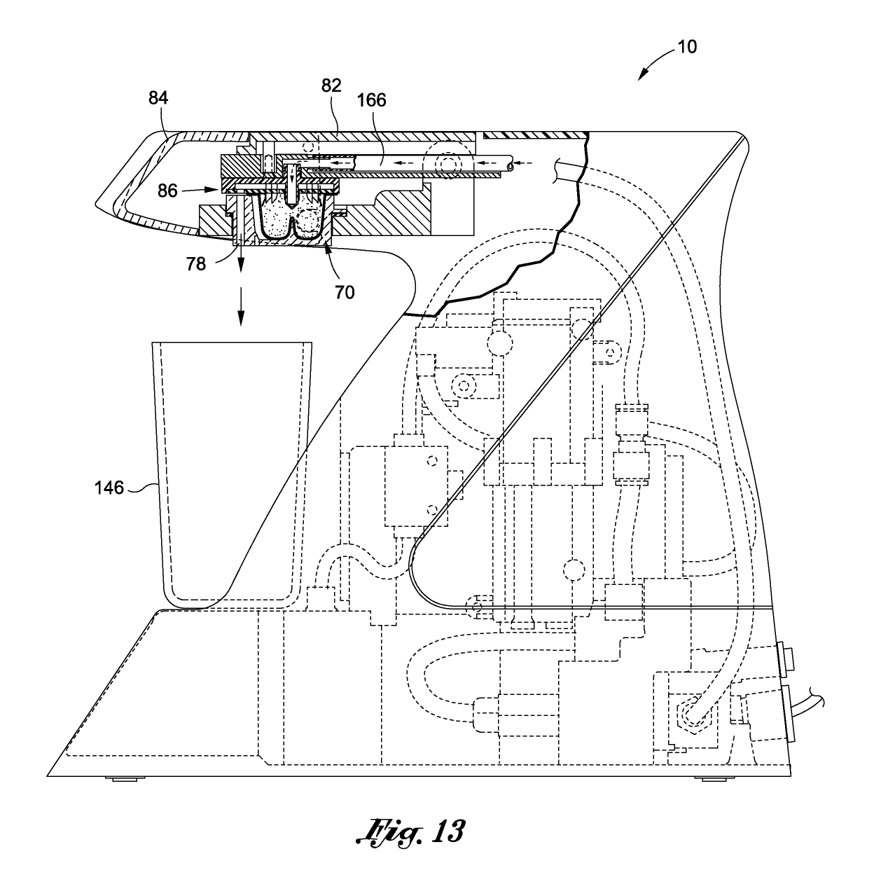

The delivery tube 166 is in fluid communication with the central inlet opening 88 such that ionized water flow from the delivery tube 166 and out of the central inlet opening 88 via the inlet spear 92. FIG. 12 is an enlarged view showing the fluid flow into the beverage capsule 52, mixing within the capsule 52, and flowing out of the capsule 52. The fluid enters the beverage capsule 52 via the inlet spear 92, which includes a plurality of spear outlets 168 formed adjacent a distal tip thereof. The spear outlets 168 are preferably arranged in a radial pattern around the outer circumference of the inlet spear 92.

The water flows out of the spear outlets 168 and enters the inner cavity 76 of the beverage capsule 52 to mix with the beverage media 60 stored within the beverage capsule 52. According to one embodiment, the beverage capsule 52 is specifically configured and adapted to define a fluid flow within the beverage capsule 52 which promotes mixing of the ionized water and the beverage media 60. In the exemplary embodiment, the capsule body 54 includes a closed end portion having a toroidal configuration. The toroidal configuration includes a central spine 170 extending into the center of the capsule body 54 and defining an annular cavity disposed about the central spine 170. The toroidal configuration creates a turbulent fluid flow within the capsule body 54 to promote rapid mixing of the ionized water and the beverage media 60, especially in ambient or cold temperature beverages.

The ionized water mixes with the beverage media 60 to create the desired beverage, which flows out of the beverage capsule 52 through the outlet openings 90. In this regard, according to one aspect of the present invention, the beverage flows in an upward direction, e.g., against the force of gravity and traverses a horizontal plane, to exit the beverage capsule 52.

The beverage flows out of the outlet openings 90 and into the dispensing head flow passageway 126. The beverage is then dispensed through the exit opening 124 and ultimately through the dispensing opening 78 in the capsule holding body 70. The dispensed beverage is captured by a beverage receptacle 146 which is placed beneath the dispensing opening, as shown in FIG. 13.

The unique configuration of the beverage dispensing device 10 provides several advantages over conventional single serve beverage dispensers. One advantage is that the primary water reservoir 18 serves two purposes. The primary water reservoir 18 initially serves the purposes of an inlet water reservoir from which water is drawn and fed to the ionizer 136. The primary water reservoir 18 also serves as the ionized water reservoir to receive the alkaline water from the ionizer 136. The ionized water is subsequently drawn by the pump for mixing within the beverage capsule.

Another unique advantage provided by the beverage dispensing device 10 is the three-way valve 132 which is configured to transition between an ionizing mode and a mixing mode to direct fluid through the device 10.

Additional advantages of the beverage dispensing device 10 relate to the dispensing head 86 and the beverage capsule 52. In particular, the dispensing head 86 uniquely includes a single central input spear 92 with several outlet openings 90 disposed about the spear 92. Furthermore, the plurality of spear outlet 168 creates a radial spray, which promotes mixing of the water and the beverage media. Moreover, the unique location of the outlet openings 90 on top of the beverage capsule 52 when the dispensing arm 48 is in the closed position requires the beverage to exit via the top of the capsule 52, which prevents clogging during operation.

Another advantage relates to the ease at which the device 10 may be cleaned. Along these lines, the dispensing head body 96 and dispensing head insert 98 are detachable from each other and the housing 12 for easy cleaning. The capsule holding body 70 may also be removed to clean the capsule holding cavity 76 as well as the dispensing outlet 78.

A further advantage of the device 10 pertains to the operational safeguards built into the device 10. Along these lines, the device 10 preferably includes a primary sensor 156 to ensure there is a sufficient level of water in the primary water reservoir 18 when the pump 130 begins running, so as to prevent over-heating of the pump. Furthermore, waste sensor 158 ensures that there is sufficient space in the waste water reservoir to accommodate the acidic water generated during operation of the device 10.

Additional advantage of the system relate to the unique construction of the beverage capsule 52. In particular, the beverage capsule 52 includes a capsule body 54 which serves as the mixing chamber for mixing the beverage media 60 and the water. The beverage capsule 52 additionally includes a top membrane or covering 56 which may be punctured by the dispensing head 86 as the dispensing arm 48 is lowered to the closed position, which in turn, establishes fluid communication between the dispensing head 86 and the beverage capsule 52. The beverage capsule 52 also preferably defines a toroidal shape to promote mixing within the capsule body 54. The beverage capsule 52 is also very small in size, thereby making storage of the capsule 52 easy during manufacture, retail and use.

The particulars shown herein are by way of example and for purposes of illustrative discussion of the embodiments of the present invention only and are presented in the cause of providing what is believed to be the most useful and readily understood description of the principles and conceptual aspects. In this regard, no attempt is made to show more details than is necessary for a fundamental understanding of the disclosure, the description taken with the drawings making apparent to those skilled in the art how the several forms of the presently disclosed invention may be embodied in practice.

What is claimed is:

1. A single serve beverage dispensing device configured for use with a single serve beverage capsule including a capsule body and a capsule covering coupled to the capsule body to define a capsule chamber for storing a beverage media, the single serve beverage dispensing device comprising:
a housing having a primary reservoir cavity, a waste reservoir cavity, and a capsule holder configured to be selectively engageable with the beverage capsule;
a dispensing arm coupled to the housing and transitional relative to the housing between open and closed positions, the dispensing arm moving toward the capsule holder as the dispensing arm transitions from the open position to the closed position, the dispensing arm including:
a dispensing head having a central inlet opening and a plurality of outlet openings disposed about the inlet opening; and
a plurality of outlet spears coupled to the dispensing head and positioned adjacent respective ones of the plurality of outlet openings, the plurality of outlet spears being configured to puncture the capsule covering when the beverage capsule is engaged with the capsule holder and the dispensing arm is moved to the closed position;
a primary water reservoir body defining a primary water reservoir and configured to be removably insertable within the primary reservoir cavity;
a waste water reservoir body defining a waste water reservoir and configured to be removably insertable within the waste reservoir cavity;
an ionizer in fluid communication with the primary water reservoir, the waste water reservoir, the ionizer being configured to produce alkaline water and acidic water from water in the primary water reservoir; and
a pump in fluid communication with the primary water reservoir, the ionizer, the waste water reservoir and the inlet opening;
the pump being configured to complete an ionizing cycle wherein water from the primary water reservoir is pumped through the ionizer, the alkaline water being pumped to the primary water reservoir and the acidic water being pumped to the waste water reservoir;
the pump being configured to complete a beverage mixing cycle wherein alkaline water from the primary water reservoir is pumped through the inlet opening to mix with beverage media in the beverage capsule and exits the beverage capsule through the plurality of outlet openings.

2. The dispensing device recited in claim 1, further comprising a three-way valve in fluid communication with the primary water reservoir, the ionizer and the inlet opening, the three-way valve having a primary reservoir inlet, an ionizing outlet, and a mixing outlet, during the ionizing cycle, the three-way valve being configured to effectuate fluid communication between the primary water reservoir and the ionizer by opening the primary reservoir inlet and the ionizing outlet and closing the mixing outlet, during the beverage mixing cycle, the three-way valve being configured to effectuate fluid communication between the primary water reservoir and the inlet opening by opening the primary reservoir inlet and the mixing outlet and closing the ionizing outlet.

3. The dispensing device recited in claim 1, wherein the plurality of outlet openings are disposed about the inlet opening in a radial pattern.

4. The dispensing device recited in claim 1, wherein the dispensing head is disposed above the capsule holder when the dispensing arm is in the closed position such that the water flows against the force of gravity to traverse a horizontal plane when the water exits the beverage capsule through the plurality of outlet openings.

5. The dispensing device recited in claim 1, wherein the dispensing arm further includes an inlet spear disposed adjacent the inlet opening.

6. The dispensing device recited in claim 1, wherein the capsule holder includes:
a capsule holding plate defining a holding aperture; and
a removable capsule holding body insertable within the holding aperture and engageable with the beverage capsule.

7. The dispensing device recited in claim 6, wherein the capsule holding body includes a dispensing opening in communication with the plurality of outlet openings when the capsule holding body is inserted within the capsule holding aperture and the dispensing arm is in the closed position.

8. The dispensing device recited in claim 7, wherein the plurality of outlet openings are fluidly coupled to the dispensing opening via an outlet passageway formed within the dispensing arm, the outlet passageway being substantially perpendicular to the dispensing opening when the dispensing arm is in the closed position.

9. The dispensing device recited in claim 1, wherein the dispensing arm includes an arm base, the dispensing head being detachably engageable with the arm base.

10. A single serve beverage dispensing system comprising:
a single serve beverage capsule including:
a capsule body; and
a capsule covering coupled to the capsule body to define a capsule chamber for storing a beverage media;
a housing having a primary reservoir cavity, a waste reservoir cavity, and a capsule holder configured to be selectively engageable with the beverage capsule;
a dispensing arm coupled to the housing and transitional relative to the housing between open and closed positions, the dispensing arm moving toward the capsule holder as the dispensing arm transitions from the open position to the closed position, the dispensing arm including:
an dispensing head having a central inlet opening and a plurality of outlet openings disposed about the inlet opening; and
a plurality of outlet spears coupled to the dispensing head and positioned adjacent respective ones of the plurality of outlet openings, the plurality of outlet spears being configured to puncture the capsule covering when the beverage capsule is engaged with the capsule holder and the dispensing arm is moved to the closed position;
a primary water reservoir body defining a primary water reservoir and configured to be removably insertable within the primary reservoir cavity;
a waste water reservoir body defining a waste water reservoir and configured to be removably insertable within the waste reservoir cavity;
an ionizer in fluid communication with the primary water reservoir, the waste water reservoir, the ionizer being configured to produce alkaline water and acidic water from water in the primary water reservoir; and
a pump in fluid communication with the primary water reservoir, the ionizer, the waste water reservoir and the inlet opening;
the pump being configured to complete an ionizing cycle wherein water from the primary water reservoir is pumped through the ionizer, the alkaline water being pumped to the primary water reservoir and the acidic water being pumped to the waste water reservoir;
the pump being configured to complete a beverage mixing cycle wherein alkaline water from the primary water reservoir is pumped through the inlet opening to mix with beverage media in the beverage capsule and exits the beverage capsule through the plurality of outlet openings.

11. The single serve beverage dispensing system recited in claim 10, wherein the capsule body defines a closed end portion opposite the capsule covering.

12. The single serve beverage dispensing system recited in claim 11, wherein the closed end portion includes a central projection extending into the internal chamber.

13. The dispensing device recited in claim 10, further comprising a three-way valve in fluid communication with the primary water reservoir, the ionizer and the inlet opening, the three-way valve having a primary reservoir inlet, an ionizing outlet, and a mixing outlet, during the ionizing cycle, the three-way valve being configured to effectuate fluid communication between the primary water reservoir and the ionizer by opening the primary reservoir inlet and the ionizing outlet and closing the mixing outlet, during the beverage mixing cycle, the three-way valve being configured to effectuate fluid communication between the primary water reservoir and the inlet opening by opening the primary reservoir inlet and the mixing outlet and closing the ionizing outlet.

14. The dispensing device recited in claim 10, wherein the dispensing head is disposed above the capsule holder when the dispensing arm is in the closed position such that the water flows against the force of gravity to traverse a horizontal plane when the water exits the beverage capsule through the plurality of outlet openings.

15. The dispensing device recited in claim 10, wherein the dispensing arm further includes an inlet spear disposed adjacent the inlet opening.

16. The dispensing device recited in claim 10, wherein the capsule holder includes:
a capsule holding plate defining a holding aperture; and
a removable capsule holding body insertable within the holding aperture and engageable with the beverage capsule.

17. The dispensing device recited in claim 16, wherein the capsule holding body includes a dispensing opening in communication with the plurality of outlet openings when the capsule holding body is inserted within the capsule holding aperture and the dispensing arm is in the closed position.

18. The dispensing device recited in claim 17, wherein the plurality of outlet openings are fluidly coupled to the dispensing opening via an outlet passageway formed within the dispensing arm, the outlet passageway being substantially perpendicular to the dispensing opening when the dispensing arm is in the closed position.

19. The dispensing device recited in claim 10, wherein the dispensing arm includes an arm base, the dispensing head being detachably engageable with the arm base.

20. A single serve beverage capsule for storing a beverage media and for use with a beverage dispensing device, the beverage capsule comprising:
a capsule body having a closed end portion and an opposing open end portion, the closed end portion defining a toroidal configuration to promote a turbulent fluid flow for a fluid impinging upon the closed end portion; and
a capsule covering coupled to the capsule body to cover the open end portion to define a capsule chamber for storing the beverage media, the capsule covering being puncturable by the beverage dispensing device to define a fluid inlet and a fluid outlet.

21. The single serve beverage capsule recited in claim 20, wherein the capsule covering is coupled to the capsule body via heat sealing.

22. The single serve beverage capsule recited in claim 20, wherein the capsule covering is coupled to the capsule body via an adhesive.

23. The single serve beverage capsule recited in claim 20, wherein the capsule covering is puncturable by the beverage dispensing device to define the fluid inlet and the fluid outlet, the fluid inlet and fluid outlet being in spaced relation to each other.

24. A method of producing a single-serve beverage comprising the steps of:
providing a single serve beverage dispenser including:
a primary water reservoir;
a waste water reservoir;
an ionizer in fluid communication with the primary water reservoir and the waste water reservoir; and
filling the primary water reservoir with water;
pumping the water from the primary water reservoir through the ionizer to produce alkaline water and acidic water;
routing the alkaline water to the primary water reservoir;
routing the acidic water to the waste reservoir; and
using the alkaline water in the primary water reservoir to make a single serve beverage by mixing the alkaline water with beverage media in a single serve beverage capsule.
